(19) United States
(12) Patent Application Publication
(10) Pub. No.: US 2024/0370965 A1
(43) Pub. Date: Nov. 7, 2024

(54) TRAVERSAL RECURSION FOR ACCELERATION STRUCTURE TRAVERSAL

(71) Applicant: ADVANCED MICRO DEVICES, INC., Santa Clara, CA (US)

(72) Inventors: Saurabh Sharma, Santa Clara, CA (US); Hashem Hashemi, Roseville, CA (US); Ian Richard Beaumont, New South Wales (AU); Jeffrey C. Allan, Boxborough, MA (US); Dana Schaa, Santa Clara, CA (US)

(21) Appl. No.: 18/373,004

(22) Filed: Sep. 26, 2023

Related U.S. Application Data
(60) Provisional application No. 63/463,331, filed on May 2, 2023.

(51) Int. Cl. G06T 1/20

(52) U.S. Cl. CPC G06T 1/20

(57) ABSTRACT

A processing unit includes traversal recursion circuitry that performs, on behalf of a software shader, at least some of the requisite actions for traversing selected types of nodes of the acceleration structure. In response to identifying a first node of a raytracing acceleration structure is of a first type, the processing unit provides an intersection result for the first node to recursion circuitry. In response to the intersection result for the first node, the processing unit performs a traversal operation for the raytracing acceleration structure at the recursion circuitry.

### BACKGROUND

To improve the fidelity and quality of generated images, some software, and associated hardware, implement ray tracing operations, wherein the images are generated by tracing the path of light rays associated with the image. Some of these ray tracing operations employ a tree structure, such as a bounding volume hierarchy (BVH) tree, to represent a set of geometric objects within a scene to be rendered. The geometric objects (e.g., triangles or other primitives) are enclosed in bounding boxes or other bounding volumes that form leaf nodes of the tree structure, and then these nodes are grouped into sets, with each set enclosed in its own bounding volume that is represented by a parent node on the tree structure, and these sets then are bound into larger sets that are similarly enclosed in their own bounding volumes that represent a higher parent node on the tree structure, and so forth, until there is a single bounding volume representing the top node of the tree structure and which encompasses all lower-level bounding volumes.

To perform some ray tracing operations, the tree structure is used to identify potential intersections between generated rays and the geometric objects in the scene by traversing the nodes of the tree, where at each node being traversed a ray of interest is compared with the bounding volume of that node to determine if there is an intersection, and if so, continuing on to a next node in the tree, where the next node is identified based on the traversal algorithm, and so forth. However, conventional approaches to traversing the tree structure sometimes consume a relatively high amount of system resources, or require a relatively large amount of time, thus limiting the overall quality of the resulting images.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing unit that employs traversal recursion circuitry to generate operations for traversing an acceleration structure in accordance with some embodiments.

FIG. 2 is a diagram illustrating an example of a bounding volume hierarchy to be traversed in part based on operations generated by the traversal recursion circuitry of FIG. 1, in accordance with some embodiments.

FIG. 3 is a block diagram illustrating an example of the traversal recursion circuitry of FIG. 1 generating operations to traverse the acceleration structure in accordance with some embodiments.

FIG. 4 is a flow diagram of a method of using traversal recursion circuitry to traverse an acceleration structure in accordance with some embodiments.

FIG. 5 is a block diagram of a processing system including the processing unit of FIG. 1 in accordance with some embodiments.

### DETAILED DESCRIPTION

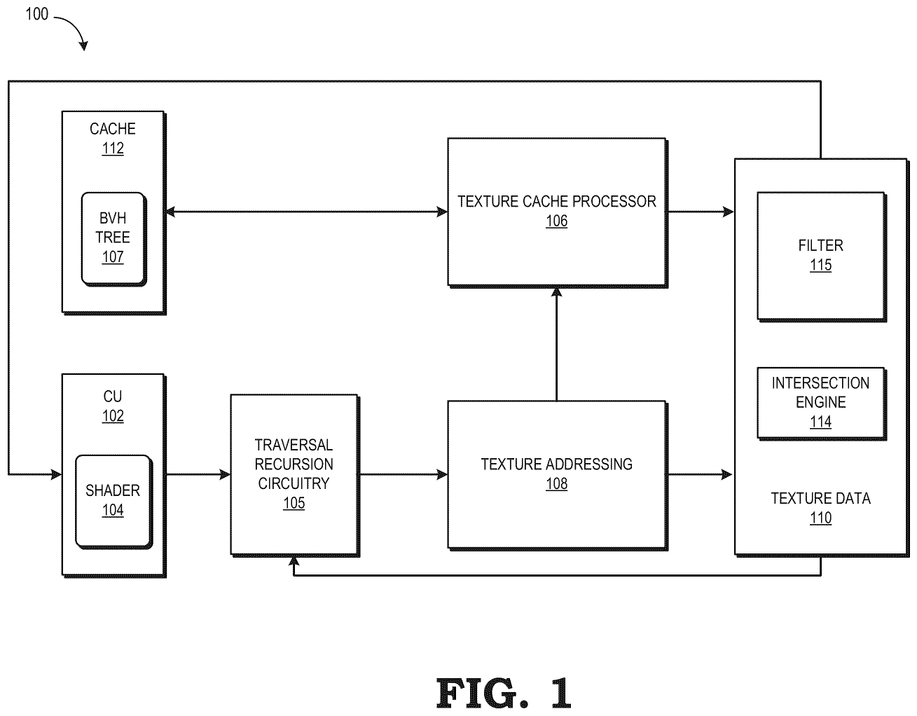

FIGS. 1-4 illustrate techniques directed to reducing the number of operations associated with acceleration traversal by employing hardware traversal recursion circuitry to reduce the number of operations generated by a software shader in accordance with some embodiments. The traversal recursion circuitry performs, on behalf of the software shader, at least some of the requisite actions for traversing selected types of nodes of the acceleration structure. For example, in some embodiments the traversal recursion circuitry generates address pointers associated with the child nodes of an intersected box node of a BVH tree. At least some acceleration structure traversal operations are thus performed by hardware, rather than the shader, thus improving the overall efficiency of the traversal process.

To illustrate via an example, when traversing a BVH tree, a graphics processing unit performs an intersection test using a set of circuitry referred to as an intersection engine (IE). In particular, the IE performs intersection tests for one or more nodes of the BVH, followed by intersection tests for the children of any intersected nodes. The process is repeated until all intersections have been found. Conventionally, after each intersection test by the intersection engine, the results of the intersection test are provided to a shader for further action. For example, the shader determines the address pointers for the child nodes of each intersected node. This results in the shader performing a relatively high number of overall operations associated with BVH traversal, thus reducing the overall efficiency of the traversal process.

In contrast to a conventional processing unit, a processing unit employing the techniques described herein employs hardware traversal recursion circuitry to reduce the number of operations generated by the shader for BVH traversal. In some embodiments, the BVH includes at least two types of nodes (and where nodes can have more than one type): box nodes and triangle nodes. The processing unit includes texture data (TD) hardware to execute operations for BVH traversal and includes an intersection engine (IE) to perform intersection tests for nodes of the BVH, where address information for the nodes is provided by texture address (TA) hardware. The IE provides intersection results along different paths depending on the type of node for which the corresponding intersection test was performed. For example, in some embodiments the processing unit includes a path for intersection results generated by the IE for box nodes, and a different path for results generated by the IE for triangle nodes. For triangle nodes, the IE provides the intersection results along one path to a shader executing at a compute unit (CU). Based on the intersection results, the shader generates corresponding operations, including operations for the TA hardware to generate address pointers for the next set of nodes to be provided to the IE.

For box nodes, the IE provides the intersection results to traversal recursion circuitry along a different path. The traversal recursion circuitry is configured to generate operations based on the intersection results. For example, in some embodiments the traversal recursion circuitry generates operations similar to the operations that would be generated by the shader if the shader were provided with the intersection results. In some embodiments, the traversal recursion circuitry generates operations for the TA hardware. Based on the generated operations, the TA hardware generates address pointers for the next set of nodes to be tested by the IE. Thus, the traversal operations for box nodes are generated, at least in part, by hardware traversal recursion circuitry, rather than by the shader. This improves the overall efficiency of the BVH traversal process.

For purposes of description, FIGS. 1-4 are described with respect to examples wherein traversal recursion circuitry is implemented at a GPU and the CPU performs a traversal process to traverse a BVH tree. However, it will be appreciated that, in other embodiments, the techniques described herein are implemented at different types of processing units, are implemented to traverse a different type of acceleration structure, or any combination thereof. For example, in different embodiments the techniques described herein are employed at any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like).

FIG. 1 illustrates a block diagram of a GPU 100 generally configured to perform ray tracing and other graphical operations on behalf of a processing system in accordance with some embodiments. The processing system is generally configured to execute sets of instructions (e.g., computer programs) to perform specified tasks on behalf of an electronic device. Accordingly, in different embodiments, the GPU 100 is incorporated into any one of a number of electronic devices, such as a desktop computer, laptop computer, server, smartphone, tablet, game console, and the like.

The GPU 100 is configured to receive commands (e.g., draw commands) from another processing unit (not shown) of the processing system, to generate one or more commands based on the received commands, and to execute the generated commands by performing one or more graphical operations. At least some of those generated commands require texture operations, including ray tracing operations. To facilitate execution of the texture operations, the GPU 100 includes a compute unit (CU) 102, a texture cache processor (TCP) 106, a texture addressing (TA) circuitry 108, a texture data (TD) circuitry 110, a cache 112, and traversal recursion circuitry 105.

The CU 102 includes one or more processing elements (that is, sets of processing circuitry) that are collectively configured to execute a shader 104. The shader 104 is a set of instructions that manipulate the circuitry of the CU 102 to perform shading operations based on commands received by the GPU 100. Examples of these shading operations include execution of material shaders, tessellation shaders, hull shaders, vertex shaders, ray tracing shaders, and the like. In the course of executing these shading operations, in at least some cases the CU 102 generates data for provision to other circuitry of the GPU 100.

The cache 112 is a memory configured to store cached data used for operations at the GPU 100, including ray tracing and other texture operations. In the depicted embodiment, the cache 112 stores a BVH tree 107 (referred to hereinafter as BVH 107) that is employed by the GPU 100 to implement ray tracing operations. The BVH 107 includes a plurality of nodes organized as a tree, with bounding boxes or other bounding volumes that forming leaf nodes of the tree structure, and then these nodes are grouped into small sets, with each set enclosed in their own bounding volumes that represent a parent node on the tree structure, and these small sets then are bound into larger sets that are likewise enclosed in their own bounding volumes that represent a higher parent node on the tree structure, and so forth, until there is a single bounding volume representing the top node of the BVH 107 and which encompasses all lower-level bounding volumes.

The TA circuitry 108 is circuitry generally configured to perform addressing tasks associated with texture operations, including ray tracing operations, based on received commands. For example, in some embodiments, the TA circuitry 108 receives ray tracing commands with pointers to particular data to be used for ray tracing, such as ray data and BVH node data. The TA circuitry 108 identifies the memory addresses associated with the pointer. The TA circuitry 108 then provides the memory addresses to the TCP 106.

The TCP 106 is circuitry configured to store and retrieve data from the cache 112 based on received memory addresses, and to provide retrieved data to other circuitry of the GPU 100, such as the TD circuitry 110. For example, the TCP 106 is configured to receive memory addresses from the TA circuitry 108 indicating one or more nodes of the BVH 107. The TCP 106 is further configured to retrieve ray data from the cache 112 based on the received addresses, wherein the retrieved ray data is ray for the indicated nodes of the BVH 107.

The TD circuitry 110 includes one or more circuits collectively configured to execute ray tracing and other texture operations based on data received from the TA circuitry 108. In particular, the TD circuitry 110 is configured to perform intersection operations, to identify whether a given ray intersects with a given BVH node, and filtering operations. To facilitate these operations, the TD 110 includes an intersection engine (IE) 114 and a filter 115.

The IE 114 is configured to receive ray data, identifying a particular ray to be used for ray tracing, and node data, indicating a node of the BVH tree 107. The IE 114 executes a node intersection process to identify whether the ray intersects with the node (referred to as an intersection hit) or does not intersect with the node (referred to as an intersection miss). The IE 114 generates intersection miss and intersection hit data, along with ray data and BVH node data.

To traverse the BVH 107, the GPU 100 is generally configured to identify a node of the BVH 107, employ the IE 114 to performing a node intersection test for the node, and perform one or more traversal operations based on the results of the intersection test. Examples of these traversal operations include identifying a next node of the BVH 107 to be tested for intersection with a ray; execution of a shader to be executed (e.g., an any-hit shader); and identifying an end of the tree traversal process for the current ray, and taking specified action based on the collective results for the traversal process. In some embodiments, the number and complexity of the traversal operations to be executed based on a given node intersection test depend on one or more of the type of node being tested, the results of the intersection test and the like.

For example, for some types of nodes of the BVH 107 an intersection hit triggers relatively simple traversal operations, such as identification of the addresses for a next node of the BVH 107 to be tested. For other types of nodes, an intersection hit triggers more complex traversal operations, such as execution of a particular shader. Accordingly, to support efficient execution of both relatively simple traversal operations and more complex traversal operations, the GPU 100 includes two paths for intersection test results. In particular, when the IE 114 identifies an intersection hit that is to result in a more complex set of traversal operations, the TD 110 provides the intersection test results to the shader 104. When the IE 114 identifies an intersection hit that is to result in a relatively simple set of traversal operations, the TD 110 provides the intersection results to the traversal recursion circuitry 105. The traversal recursion circuitry 105 is circuitry configured to perform traversal operations, such as pointer generation, in hardware, and based on intersection results from the TD 110.

To illustrate, in some embodiments the BVH tree 107 includes at least two types of nodes: box nodes, corresponding to nodes representing regions of an image, and including one or more child nodes, and triangle nodes, representing triangles of the image. The triangles represented by the triangle nodes collectively form objects of the image for which raytracing is performed. In at least some cases, an intersection hit for a box node triggers the execution of a relatively simple set of traversal operations: the determination of address pointers for the child nodes of the box nodes. In contrast, an intersection hit for a triangle node triggers execution of a more complex set of traversal operations, such as execution of shader operations. Accordingly, in some embodiments the traversal recursion circuitry 105 includes circuitry such as one or more arithmetic logic units and logic circuitry to implement one or more state machines, wherein the state machines are configured to execute address pointer calculations similar to or the same as the shader 104. In response to the IE 114 identifying an intersection hit for a box node, the TD 110 provides the intersection results to the traversal recursion circuitry 105. In response, the traversal recursion circuitry 105 generates address pointers to the child nodes of the intersected box node. This offloads the task of address generation for intersected box nodes from the shader 104 to the traversal recursion circuitry 105, improving the overall efficiency of the BVH traversal.

The filter 115 is texture filter circuitry, generally configured to perform texture filter operations. For example, in some embodiments the filter 115 performs bilinear filtering operations for raytracing.

As set forth above, one or more elements of the GPU 100, such as TCP 106, texture addressing circuitry 108, texture data circuitry 110, and traversal recursion circuitry 105 are implemented as hardware that is hard-wired (e.g., circuitry) to perform the various operations described herein.

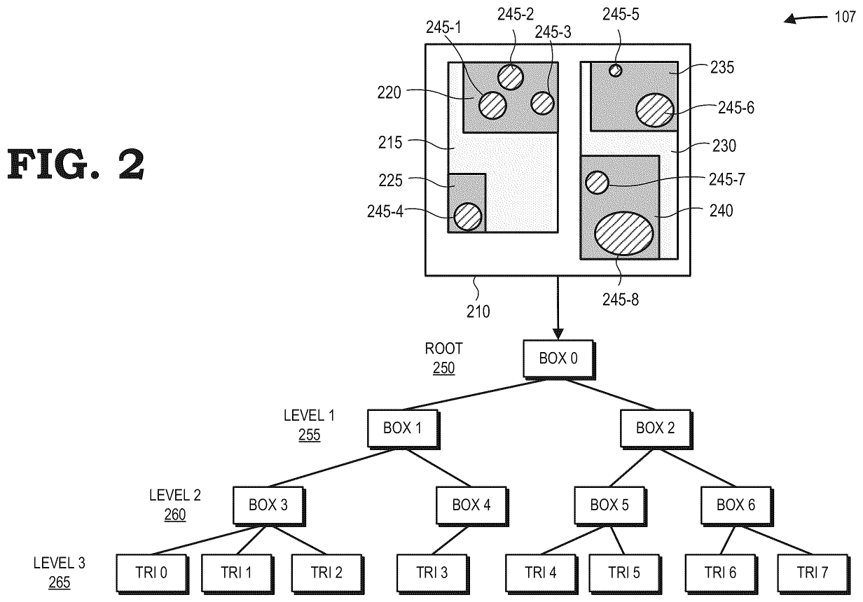

Referring now to FIG. 2, a diagram of an example BVH 107 used for one or more frustum queries is presented. In embodiments, the BVH 107, includes data representing one or more graphics objects 245 of a scene to be rendered in screen space 210 (e.g., a display space). As an example, BVH 107 includes levels of nodes representing hierarchically arranged bounding boxes, bounding volumes, or both that each encompasses one or more graphics objects 245, portions of one or more graphics objects (e.g., meshlets), or both within the scene to be rendered in a screen space 210. Such graphics objects 245, for example, each include data representing a set of primitives within a scene. Though the example embodiment of FIG. 2 presents the scene in screen space 210 as having eight graphics objects (245-1, 245-2, 245-3, 245-4, 245-5, 245-6, 245-7, 245-8), in other embodiments, the scene in screen space 210 can have any number of graphics objects 245.

According to embodiments, to represent one or more graphics objects 245 of a scene to be rendered in screen space 210, BVH 107 includes a data structure having two or more hierarchical levels that each include a number of nodes. As an example, BVH 107 includes a first hierarchical level (e.g., root 250) that includes a single node (e.g., Box 0) that represents all the graphics objects (245-1, 245-2, 245-2, 245-4, 245-5, 245-6, 245-7, 245-8) in screen space 210. Further, BVH 107 includes a second level (e.g., level 1 255) that includes a first node (e.g., Box 1) and a second node (e.g., Box 2) each connected to the node (e.g., Box 0) of the first hierarchical level. The nodes of the second level (e.g., level 1 255) together represent a first set of bounding boxes 215, 230 in screen space 210 encompassing the graphics objects 245. For example, a first node (e.g., Box 1) of the second hierarchical level (e.g., level 1 255) represents a first bounding box 215 encompassing the graphics objects 245-1, 245-2, 245-3, 245-4 and a second node (e.g., Box 2) of the second hierarchical level represents a second bounding box 230 encompassing the graphics objects 245-5, 245-6, 245-7, 245-8. In embodiments, BVH 107 also includes a third hierarchical level (e.g., level 2 260) that includes a first node (e.g., Box 3), second node (e.g., Box 4), third node (e.g., Box 5), and a fourth node (e.g., Box 6) each connected to respective nodes of the second hierarchical level. The nodes of the third level (e.g., level 2 260) together represent a second set of bounding boxes 220, 225, 235, 240 in screen space 210 encompassing the graphics objects 245. For example, a first node (e.g., Box 3) of the third hierarchical level (e.g., level 2 260) represents a third bounding box 220 encompassing the graphics objects 245-1, 245-2, 245-3, a second node (e.g., Box 4) of the third hierarchical level represents a fourth bounding box 225 encompassing graphics object 245-4, a third node (e.g., Box 5) of the third hierarchical level represents a fifth bounding box 235 encompassing the graphics objects 245-5, 245-6, and a fourth node (e.g., Box 6) of the third hierarchical level represents a sixth bounding box 240 encompassing the graphics objects 245-7, 245-8.

Additionally, according to embodiments, BVH 107 includes a fourth hierarchical level (e.g., level 3 265) that includes nodes each connected to a respective node of the third hierarchical level. For example, the fourth hierarchical level (e.g., level 3 265) includes a first node (e.g., TRI 0) representing one or more triangles of graphics object 245-1, a second node (e.g., TRI 1) representing one or more triangles of graphics object 245-2, a third node (e.g., TRI 2) representing one or more triangles of graphics object 245-3, a fourth node (e.g., TRI 3) representing one or more triangles of graphics object 245-4, a fifth node (e.g., TRI 4) representing one or more triangles of graphics object 245-5, a sixth node (e.g., TRI 5) representing one or more triangles of graphics object 245-6, a seventh node (e.g., TRI 6) representing one or more triangles of graphics object 245-7, and an eighth node (e.g., TRI 7) representing one or more triangles of graphics object 245-8.

In the illustrated example, the BVH 107 includes two types of nodes: box nodes that represent bounding boxes containing one or more objects, and triangle nodes that represent triangles for one or more objects. In some embodiments, the GPU 100 is generally configured to traverse the BVH 107 for a given ray by employing the IE 114 to identify whether the ray intersects with box node of the root 250. If not, the traversal process ends. If the ray intersects with the box node of the root 250, the GPU 100 employs the IE 114 to identify whether the ray intersects with either of the child nodes of the root node—that is, the box nodes of the first hierarchical level 255. The GPU 100 continues to traverse the BVH 107 in similar fashion, until the GPU 100 has identified which, if any, of the triangle nodes are intersected by the ray. The shader 104 then executes raytracing operations based on the identified triangle nodes, such as determining the behavior of the ray based on the intersected triangle nodes.

It will be appreciated that, for most box node intersections, the required operations for the next step of traversal are to identify the memory addresses for data associated with the child nodes of the box node. Accordingly, these operations are executed by the traversal recursion circuitry 105, thereby offloading these operations from the shader 104 and improving the efficiency of the traversal process.

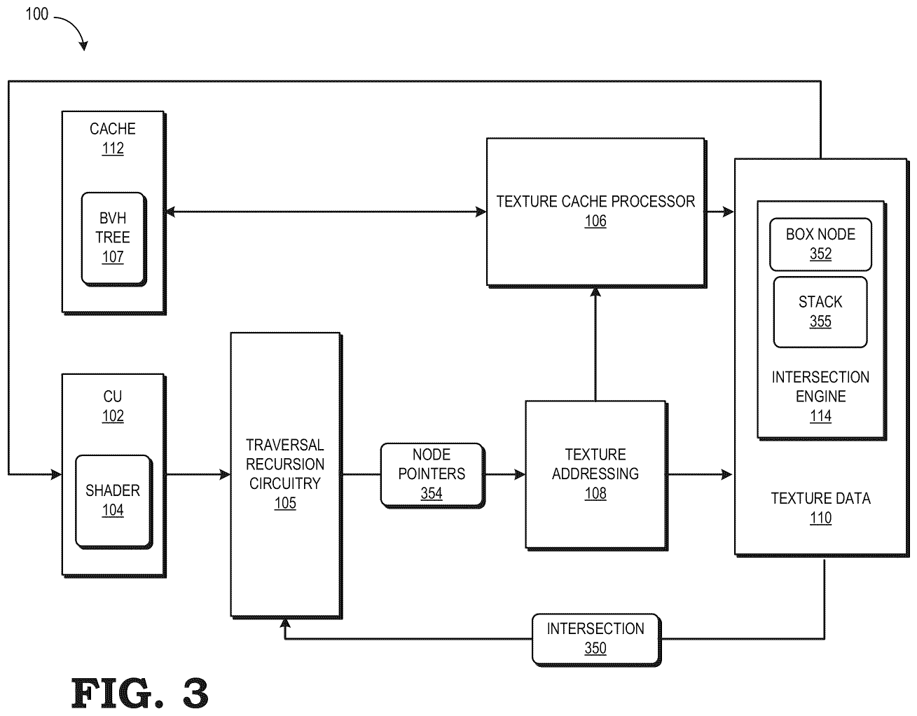

FIG. 3 illustrates an example of the GPU 100 employing the traversal recursion circuitry 105 to generate traversal operations in accordance with some embodiments. In the depicted example, the IE 114 performs an intersection test for a ray and a box node 352 of the BVH 107. For purposes of the example, it is assumed that the IE 114 determines that a ray intersects with the box node 352. Accordingly, and in response to identifying that the node 352 is a box node the IE 114 provides intersection information 350 to the traversal recursion circuitry 105. In some embodiments, the IE 114 determines that the node 352 is a box node based on the pointer associated with the node 352. For example, in some embodiments the pointer includes a field indicating the type of node associated with the pointer.

The intersection information 350 indicates the child nodes of the box node 352 that are to be tested for intersection with the ray. Based on the intersection information 350, the traversal recursion circuitry generates node pointers 354, representing pointers to the child nodes of the box node 352. The traversal recursion circuitry 105 provides the node pointers 354 to the TA 108, which generates the memory addresses for the child nodes at the cache 112. The TCP 106 uses the memory addresses to retrieve the node data for the child nodes from the cache 112, and provides the node data to the TD 110 for intersection testing at the IE 114. Thus, in the example of FIG. 3, the GPU 100 generates and executes traversal operations for the box node 352, and in particular generation of the node pointers 354, without intervention by the shader 104, thus improving the efficiency of the traversal process.

In some embodiments, the IE 114 maintains a stack 355 that stores state data for the traversal of the BVH tree 107. For example, in some embodiments, the stack 355 stores information indicating the current location (e.g., the current node) of the traversal process for the BVH tree 107, one or more remaining nodes of the BVH tree 107 to be tested for intersection, and the like. In at least some embodiments, the stack 355 is cleared, or partially cleared, when intersection information is provided to the shader 104, but data at the stack 355 is maintained for recursive operations—that is, when the intersection information 350 is provided to the traversal recursion circuitry 105. Accordingly, a relatively large stack 355 is employed for a correspondingly large number of recursive operations.

In some embodiments, to allow for a smaller stack 355, the IE 114 is configured to determine the amount of space available at the stack 355, as well as the amount of space at the stack that is expected to be consumed if the intersection information 350 is provided to the traversal recursion circuitry 105. In response to the expected amount of space consumed exceeding the amount of space available at the stack 355, the IE 114 provides the intersection information 350 to the shader 104 at the CU 102. The shader 104 then generates the node pointers 354. Further, in some embodiments the total number of recursions (that is, the number of consecutive times intersection information is provided to the traversal recursion circuitry 105 between provision of intersection information to the shader 104) is fixed by the GPU 100. For example, in some embodiments the GPU 100 stores a value in a register (e.g., in response to an instruction from an application or operating system) that indicates a threshold number of consecutive recursions. In response to determining that the number of consecutive recursions exceeds a threshold, the IE 114 provides the intersection information 350 to the shader 104. The shader 104 then generates the node pointers 354. By setting a maximum number of consecutive recursions, the GPU 100 prevents potential performance issues, such as infinite raytracing loops for an individual node, or the raytracing operations for an individual node consuming a relatively high number of processing resources.

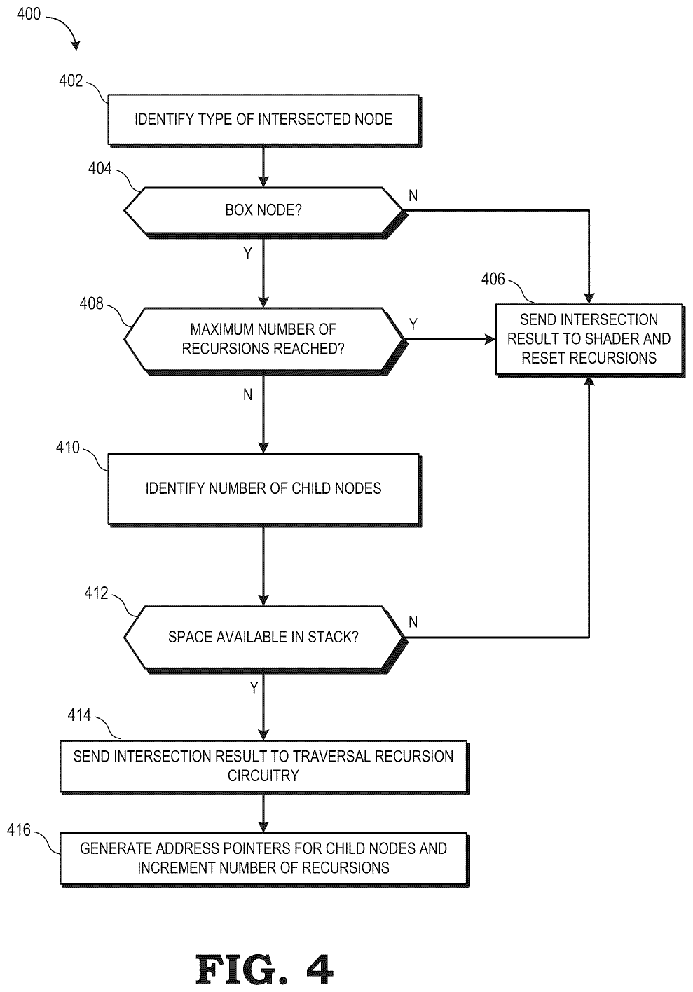

FIG. 4 illustrates a flow diagram of a method 400 of using traversal recursion circuitry to traverse an acceleration structure in accordance with some embodiments. The method 400 is described with respect to an example implementation at the GPU 100 of FIG. 1. However, it will be appreciated that in other embodiments the method 400 is implemented at a processing unit having a different configuration.

At block 402, the IE 114 performs an intersection test based on a ray and a node of the BVH 107. The intersection test indicates that the ray intersects with the node. Accordingly, the IE 114 identifies the type of node. At block 404, the IE 114 determines if the type of node that was tested is a box node. If not (e.g., if the node is identified as a triangle node), the method flow moves to block 406 and the IE 114 sends the results of the intersection test to the shader 104. In response, the shader 104 executes one or more shader operations.

If, at block 404, the IE 114 identifies that the tested node is a box node, the method flow moves to block 408 and the IE 114 determines if a specified maximum number of recursions has been reached. If so, the method flow moves to block 406 and the IE 114 sends the intersection results to the shader 104. In response, the shader 104 identifies address pointers for the child nodes of the tested node. In addition, the IE 114 resets the number of recursions.

If, at block 408, the IE 114 determines that the maximum number of recursions has not been reached, the method flow moves to block 410 and the IE 114 identifies the number of child nodes for the tested node. The number of child nodes indicates the amount of state information that is to be stored at the stack 355 for subsequent traversal steps. At block 412 the IE 114 determines if there is space available in the stack 355 to support intersection tests for all of the child nodes identified at block 410. If not, the method flow moves to block 406 and the IE 114 sends the intersection results to the shader 104. In response, the shader 104 identifies address pointers for the child nodes of the tested node. In addition, the IE 114 resets the number of recursions.

If, at block 412, the IE 114 determines that there is space available at the stack 355, the method flow moves to block 414 and the IE 114 provides the intersection result, indicating the child nodes, to the traversal recursion circuitry 105. In response, at block 416, the traversal recursion circuitry 105 generates address pointers for the child nodes of the tested node and increments the number of recursions. Thus, using the method 400, a GPU performs traversal operations, such as generating node address pointers, for selected types of nodes using dedicated hardware, rather than with a shader or other software. This reduces the number of operations performed by the software, and thus enhances the efficiency of the BVH traversal process.

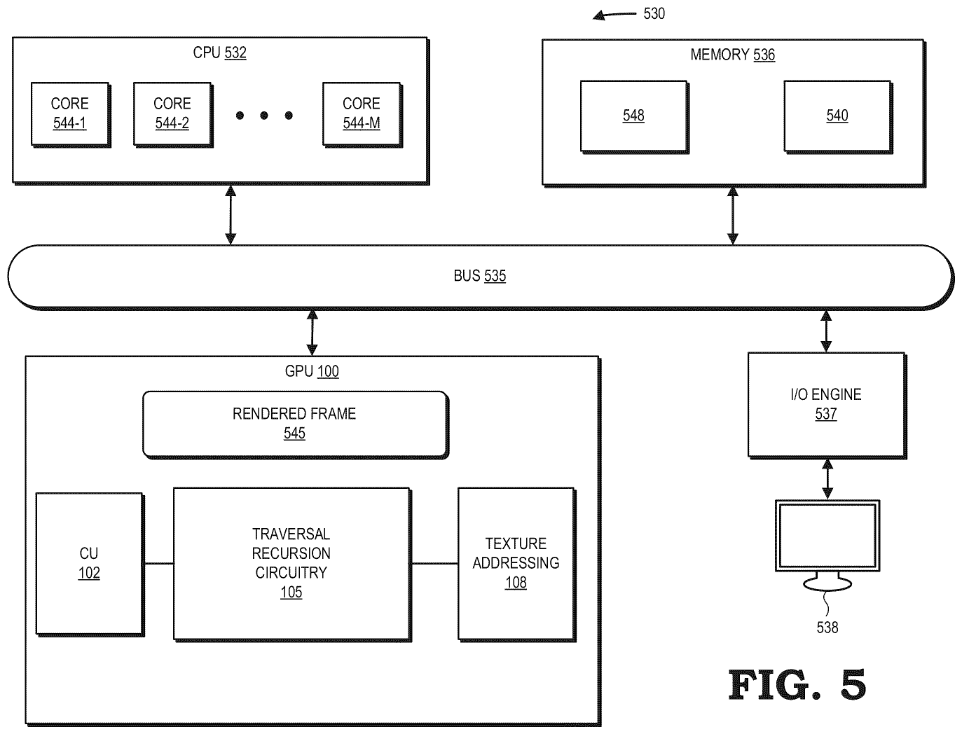

Referring now to FIG. 5, a processing system 530 configured to perform raytracing is presented, in accordance with some embodiments. Processing system 530 includes or has access to a memory 536 or other storage component implemented using a non-transitory computer-readable medium, for example, a dynamic random-access memory (DRAM). However, in implementations, the memory 536 is implemented using other types of memory including, for example, static random-access memory (SRAM), nonvolatile RAM, and the like. According to implementations, the memory 536 includes an external memory implemented external to the processing units implemented in the processing system 530. The processing system 530 also includes a bus 535 to support communication between entities implemented in the processing system 530, such as the memory 536. Some implementations of the processing system 530 include other buses, bridges, switches, routers, and the like, which are not shown in FIG. 1 in the interest of clarity.

The processing system 530 includes the GPU 100 to implement one or more of the techniques described herein The GPU 100 is configured to render a set of rendered frames each representing respective scenes within a screen space (e.g., the space in which a scene is displayed) according to one or more applications 540 for presentation on a display 538. As an example, the GPU 100 renders graphics objects (e.g., sets of primitives) for a scene to be displayed so as to produce pixel values representing a rendered frame 545. In at least some embodiments, the rendered frame 545 is based on raytracing operations executed at the traversal recursion circuitry 105 and texture addressing circuitry 108 as described herein. The GPU 100 then provides the rendered frame 545 (e.g., pixel values) to display 128. These pixel values, for example, include color values (YUV color values, RGB color values), depth values (z-values), or both. After receiving the rendered frame 545, display 538 uses the pixel values of the rendered frame 545 to display the scene including the rendered graphics objects. To render the graphics objects, the GPU 100 implements processor cores (not shown) that execute instructions concurrently or in parallel. In embodiments, one or more processor cores of the GPU 100 each operate as a compute unit (e.g., CU 102) configured to perform one or more operations for one or more instructions received by the GPU 100. These compute units each include one or more single instruction, multiple data (SIMD) units that perform the same operation on different data sets to produce one or more results.

In embodiments, processing system 530 also includes CPU 532 that is connected to the bus 535 and therefore communicates with the GPU 100 and the memory 536 via the bus 535. CPU 102 implements a plurality of processor cores 544-1 to 544-M that execute instructions concurrently or in parallel. Though in the example implementation illustrated in FIG. 1, three processor cores (544-1, 544-2, 544-M) are presented representing an M number of cores, the number of processor cores 104 implemented in CPU 532 is a matter of design choice. As such, in other implementations, CPU 532 can include any number of processor cores 544. The processor cores 544 of CPU 532 are configured execute instructions such as program code 548 for one or more applications 540 (e.g., graphics applications, compute applications, machine-learning applications) stored in the memory 536, and CPU 532 stores information in the memory 536 such as the results of the executed instructions. CPU 532 is also able to initiate graphics processing by issuing draw calls to the GPU 100.

In some embodiments, the processing system 530 includes input/output (I/O) engine 537 that includes circuitry to handle input or output operations associated with display 538, as well as other elements of the processing system 530 such as keyboards, mice, printers, external disks, and the like. The I/O engine 537 is coupled to the bus 535 so that the I/O engine 537 communicates with the memory 536, the GPU 100, and the central processing unit (CPU) 532. In some embodiments, the CPU 532 issues one or more draw calls or other commands to the GPU 100. In response to the commands, the GPU 100 schedules, via the scheduler 102, one or more raytracing operations at the raytracing hardware 110. For at least one of the raytracing operations, the raytracing hardware 110 employs one or more work items as described above. Based on the raytracing operations, the GPU 100 generates a rendered frame, and provides the rendered frame to the display 538 via the I/O engine 537.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to identifying a first node of a raytracing acceleration structure is of a first type, providing an intersection result for the first node to traversal recursion circuitry; and
in response to the intersection result for the first node, performing a traversal operation for the raytracing acceleration structure at the traversal recursion circuitry.

2. The method of claim 1, further comprising:
in response to identifying a second node of the raytracing acceleration structure is of a second type, providing an intersection result for the second node to a shader.

3. The method of claim 2, wherein the first type is a box node.

4. The method of claim 3, wherein the second type is a triangle node.

5. The method of claim 1, wherein the traversal operation comprises generating an address pointer for a second node of the raytracing acceleration structure.

6. The method of claim 1, further comprising:
in response to identifying a number of operations generated by the raytracing acceleration structure exceeds a threshold, providing an intersection result for a second node of the raytracing acceleration structure to a shader.

7. The method of claim 1, further comprising:
providing an intersection result for a second node of the raytracing acceleration structure to a shader based on an amount of space available at a stack associated with the raytracing acceleration structure.

8. A method comprising:
identifying an intersection result for a first node of a raytracing acceleration structure; and
selecting between a shader and hardware traversal recursion circuitry based on a type of the first node.

9. The method of claim 8, wherein selecting comprises:
selecting the hardware traversal recursion circuitry in response to the first node being a box node.

10. The method of claim 9, further comprising:
in response to selecting the hardware traversal recursion circuitry, generating, at the hardware traversal recursion circuitry, an address pointer for a second node of the raytracing acceleration structure.

11. The method of claim 9, further comprising:
selecting the shader in response to the first node being a triangle node.

12. The method of claim 9, further comprising:
selecting the shader in response to a number of recursion operations generated by the hardware traversal recursion circuitry exceeding a threshold.

13. The method of claim 9, further comprising:
selecting the shader in response to an amount of space at a stack associated with the raytracing acceleration structure being below a threshold.

14. The method of claim 8, wherein the raytracing acceleration structure comprises a bounding volume hierarchy.

15. A processing unit comprising:
intersection engine circuitry to identify an intersection result for a first node of a raytracing acceleration structure; and
traversal recursion circuitry to perform a traversal operation for the raytracing acceleration structure in response to intersection result and in response to the first node being of a first type.

16. The processing unit of claim 15, further comprising:
a compute unit to execute a shader; and
wherein the intersection engine circuitry is to provide an intersection result for a second node of the raytracing acceleration structure to the shader in response to identifying the second node is of a second type.

17. The processing unit of claim 16, wherein the first type is a box node.

18. The processing unit of claim 17, wherein the second type is a triangle node.

19. The processing unit of claim 15, wherein the traversal operation comprises generating an address pointer for a second node of the raytracing acceleration structure.

20. The processing unit of claim 15, wherein the intersection engine circuitry is to:
in response to identifying a number of operations generated by the raytracing acceleration structure exceeds a threshold, provide an intersection result for a second node of the raytracing acceleration structure to a shader.
